(19) United States
(12) Patent Application Publication
(10) Pub. No.: US 2013/0309890 A1
(43) Pub. Date: Nov. 21, 2013

(54) CONNECTOR HOLDING STRUCTURE

(71) Applicant: Isao Matsui, Chiyoda-ku (JP)

(72) Inventor: Isao Matsui, Chiyoda-ku (JP)

(73) Assignee: MITSUBISHI ELECTRIC CORPORATION, Chiyoda-ku, Tokyo (JP)

(21) Appl. No.: 13/983,153

(22) PCT Filed: Mar. 10, 2011
(86) PCT No.: PCT/JP2011/055692

§ 371 Date: Aug. 1, 2013

(51) Int. Cl. H01R 13/46

(52) U.S. Cl. CPC H01R 13/46
USPC 439/296

(57) ABSTRACT

A connector holding structure includes a pair of holders each shaped substantially like a U and having a base and a pair of arms extending from both ends of the base; and levers. The pair of arms includes a connector support portion in which the distance between their inner side surfaces is narrower at positions adjacent to the base than the width of the connector opening, and notched portions for getting rid of interference with the claw tabs. The holders are placed respectively at both ends along a longitudinal direction of the connector opening and housed in the faceplate. The lever causes the faceplate to support the holder in one of a position for a holder locked state and a position for a holder released state.

### FIELD

The present invention relates to a connector holding structure.

### BACKGROUND

Conventionally, the connectors of a cable used to connect a programmable controller and a module unit are of a single-sided spring contact structure. If the connector of the cable is inclined at a certain angle or greater relative to a connector on the apparatus side, electrical connection is impaired. Further, if the connector on the cable side is inclined while the connectors being fastened, a load is put onto the substrate on which the connector on the apparatus side is mounted, and thus a signal pattern may be damaged. Hence, the inclination of the connector on the cable side relative to the connector on the apparatus side needs to be suppressed as much as possible.

Accordingly, a method of suppressing the inclination by arranging another member for surrounding the connectors has been used. For example, a faceplate mounted on a case that houses the substrate of a programmable controller is used to surround the side surface of the connector on the cable side and the inclination of the connector on the cable side is suppressed.

The faceplate is connected with the case by fitting a claw tab provided on a side surface, on which the connector is placed, of the programmable controller case into a recess in the faceplate. When considering the maintenance-ability of the substrate housed in the case, the faceplate needs to be of a structure easy to attach and detach. Hence, the claw tab for attaching the faceplate is formed so as to be bent easily to a certain degree. Thus, when the cable fitted to the connector on the apparatus side mounted on the substrate is pulled laterally, so that the connector on the cable side is inclined, a lateral force is applied to the claw tab to bend. Thus, the claw tab is detached from the recess in the faceplate before damaged, and the case and the faceplate are separated by a load smaller than the permissible load for the claw tab.

As the method of fastening the connector on the apparatus side and the connector on the cable side, a method is taken which fastens the connectors by screws. By fastening the connectors by screws, the inclination of the connector on the cable side can be suppressed to be a little. However, with this structure, the screws have to be tightened and loosened every time that the connector is attached and detached, and hence workability is harmed.

Hence, the structure may be used where a protrusion biased by a spring is provided on the connector on the cable side and is fitted into a recess provided in the connector on the apparatus side to fasten the connectors to each other. With this structure, workability in attaching and detaching is good, but because the force of fastening the connectors is weaker than that of the screw fastening, the inclination of the connector on the cable side is larger, and thus the above problem becomes more conspicuous.

Patent Literature 1 discloses a substrate connector fitting structure where the force applied to a substrate connector at the times of fitting and releasing a correspondent connector into and from the substrate connector is received by a case.

### CITATION LIST

### Patent Literature

Patent Literature 1: Japanese Patent Application Laid-open No. 10-134885

### SUMMARY

### Technical Problem

However, the above conventional art makes a force be not applied to the substrate connector at the times of connector fitting and releasing, but the art does not make a force be not applied to the substrate connector while the connectors are being fitted together. Thus, there is a problem in that the inclination of the correspondent connector relative to the substrate connector cannot be suppressed.

Further, the fit-holding of the case and the faceplate by screw-fastening secures the reliability of fitting together, but the number of man-hours for assembly work increases. Yet further, because a space for tightening screws needs to be secured, the space hinders making the product smaller and improving the aesthetic appearance of exterior design.

The present invention was made in view of the above, and an object is to provide a connector holding structure in which a tool is not needed to attach and detach the faceplate to and from the case and which can suppress the inclination of the connector on the cable side without giving a load to the substrate.

### Solution to Problem

To solve the above problems and achieve an object, there is provided a connector holding structure of a programmable controller according to the present invention which includes a lower case shaped like a box with one surface open that houses a substrate on which an apparatus-side connector is mounted and an upper case shaped like a box with one surface open in which a connector opening through which a cable-side connector penetrates to be connected to the apparatus-side connector is formed in the surface opposite to the open surface, and in which the lower case and the upper case are detachably coupled together with the open surfaces opposite each other by fitting four claw tabs provided protruding from the edges surrounding the open surface of the lower case into four recesses provided in side surfaces of the upper case and close to both ends of the connector opening, the connector holding structure including: a pair of holders each shaped substantially like a U and including a base and a pair of arms extending from both ends of the base, wherein the pair of arms includes a connector support portion in which the distance between inner side surfaces thereof is narrower at positions adjacent to the base than a width of the connector opening and notched portions for getting rid of interference with the claw tabs, and the pair of holders is placed respectively at both ends along a longitudinal direction of the connector opening and housed in the upper case; and a switching unit that causes the upper case to support the holder in one of a position for a holder locked state where the connector support portion is partly exposed through the connector opening at outer edges thereof and where the base is located in front of the claw tabs and the recesses and a position for a holder released state where the connector support portion is not exposed through the connector opening and where the notched portion is located in front of the claw tabs and the recesses.

### Advantageous Effects of Invention

The connector holding structure according to the present invention has the effect that a tool is not needed to attach and detach the faceplate to and from the case and that the structure can suppress the inclination of the connector on the cable side without giving a load to the substrate.

### BRIEF DESCRIPTION OF DRAWINGS

FIG. 1 is an exploded perspective view showing the configuration of an embodiment of the connector holding structure according to the present invention.

FIG. 2 is a perspective view of the connector holding structure.

FIG. 3 is an upside view of the connector holding structure when the holder 2 is released (a holder released state).

FIG. 4 is a schematic diagram of the connector holding structure in the holder released state.

FIG. 5 is an upside view of the connector holding structure when the holder 2 is locked (a holder locked state).

FIG. 6 is a schematic diagram of the connector holding structure in the holder locked state.

### DESCRIPTION OF EMBODIMENTS

An embodiment of the connector holding structure according to the present invention will be described in detail below with reference to the drawings. Note that this embodiment is not intended to limit the present invention.

### Embodiment

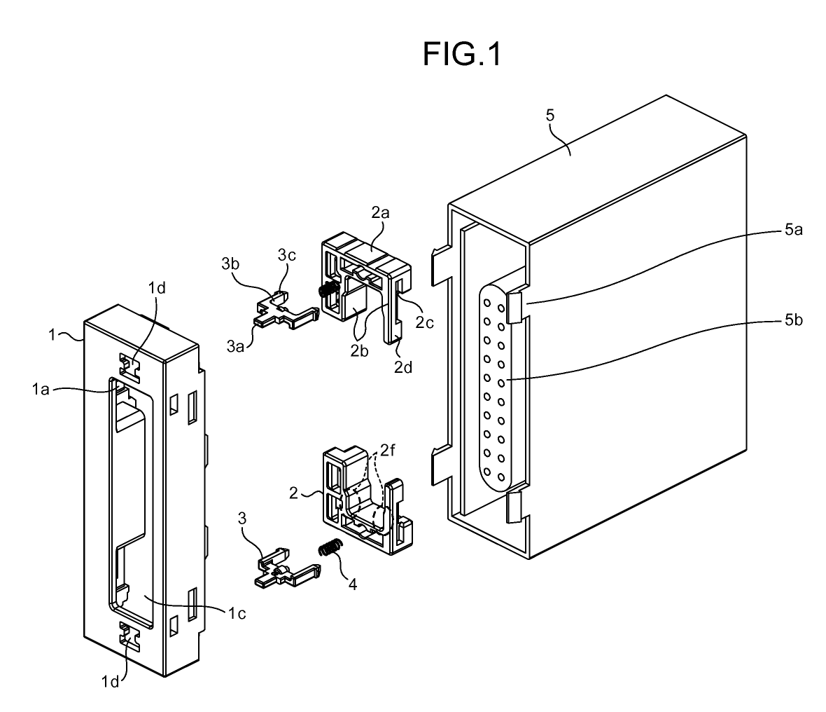

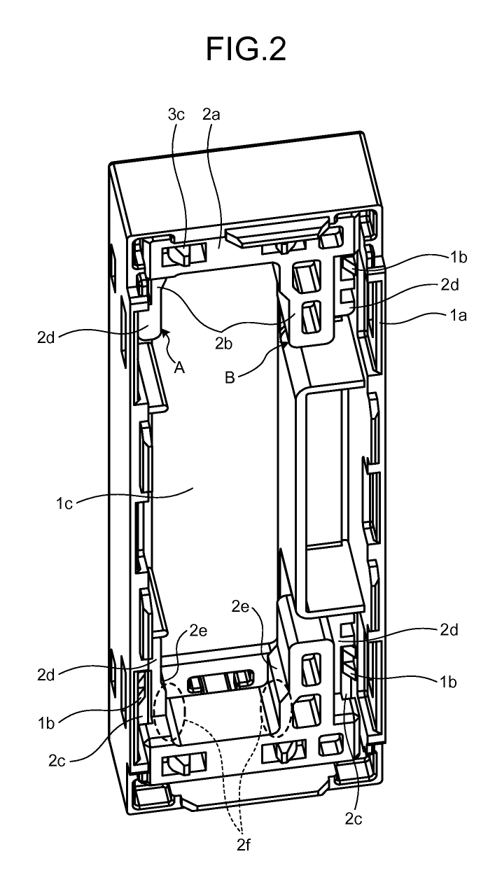

FIG. 1 is an exploded perspective view showing the configuration of an embodiment of the connector holding structure according to the present invention. FIG. 2 is a perspective view of the connector holding structure. The connector holding structure includes a faceplate (upper case) 1, holders 2, levers 3, and springs 4.

The faceplate 1 is a member to be mounted on a case 5 of a programmable controller and has recesses 1a in the inner surface of the side walls for claw tabs 5a of the case (lower case) 5 to fit into. Further, protrusions 1b are provided on the inner surface side of the side walls to prevent the falling off of the holders 2. The faceplate 1 is provided, in the upper surface, with a connector opening 1c for connecting a cable-side connector 6 (not shown in FIGS. 1, 2) to an apparatus-side connector 5b mounted on a substrate housed in the case 5 and operation openings 1d for performing operation to change the positions of the holders 2 by the levers 3. The operation openings 1d are provided respectively near both ends along a longitudinal direction of the connector opening 1c. The operation opening 1d is in a shape having a constriction in the center. Note that the direction in which the cable-side connector 6 is inserted into the apparatus-side connector 5b is defined to be “downward” and that the direction in which the cable-side connector 6 is detached from the apparatus-side connector 5b is defined to be “upward”. The case 5 and the faceplate 1 form the casing of the programmable controller.

The lever 3 includes an operation portion 3a and a fixed portion 3b and is attached to the holder 2 via a spring 4 as an elastic member such that the operation portion 3a protrudes up from the holder 2. The fixed portion 3b is forked to transmit the force applied to the operation portion 3a to the holder 2 at two points so that the holder 2 does not turn when the force is applied to the operation portion 3a. A hook 3c is provided at each end of the fixed portion 3b to prevent the lever 3 from detaching from the holder 2 by repulsion force of the spring 4. The operation portion 3a is in a shape whose width is different between the side adjacent to the fixed portion 3b and the end side, and the width of the side adjacent to the fixed portion 3b is wider.

The holder 2 is shaped substantially like a U in top view, and a pair of arms 2b is provided adjacent to both ends of a base 2a thereof. A notched portion 2d to get rid of interference with the claw tab 5a is provided in the arm 2b, and when the holder is installed in the faceplate 1, there is a space for a bend margin corresponding to the notched portion 2d in front of the claw tab 5a. The arm 2b indicated by arrow A in FIG. 2 is notched over the full width, so that the notched portion 2d stretches over the entire arm 2b. Meanwhile, the arm 2b indicated by arrow B has a notched portion stretching over only the outer side. The arm 2b has a groove 2c formed in the outer side surface. The protrusion 1b provided on the faceplate 1 is accommodated in the groove 2c to support the holder 2 from below, thereby preventing the holder 2 attached to the faceplate 1 from falling. The arm 2b needs to be bent in order to attach the holder 2 to the faceplate 1 such that the protrusion 1b is accommodated in the groove 2c. By providing, e.g., a step 2e in the inner side surface of the arm 2b so that the arm 2b is tapered as shown in FIG. 1, the arm 2b becomes easy to bend, and thus it becomes easy to attach and detach the holder 2. Because the holder 2 is accommodated in the faceplate 1, the holder 2 does not hinder making the programmable controller smaller. Since the space between the arms 2b is narrower at positions adjacent to the base 2a than the width of the connector opening 1c, parts of the arms 2b adjacent to the base 2a form a connector support portion 2f.

A metal-made spring is used as the spring 4. Note that the spring 4 may be a resin spring and formed integrally with the holder 2 and the lever 3.

The holder 2 and the lever 3 are fastened with the spring 4 in between by making the hook 3c engage with the holder 2. The holder 2 having the lever 3 fastened thereto is installed in each of the operation openings 1d so that the arms 2b hold the connector opening 1c.

Because the faceplate 1, the holder 2, the lever 3, and the spring 4 are of an engaging structure that can be disassembled, if some components are damaged, only the damaged components can be replaced while reusing the other components. Further, when being discarded, they can be recycled on a component basis.

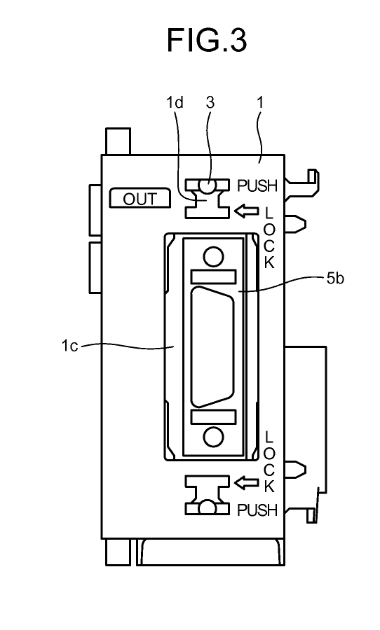

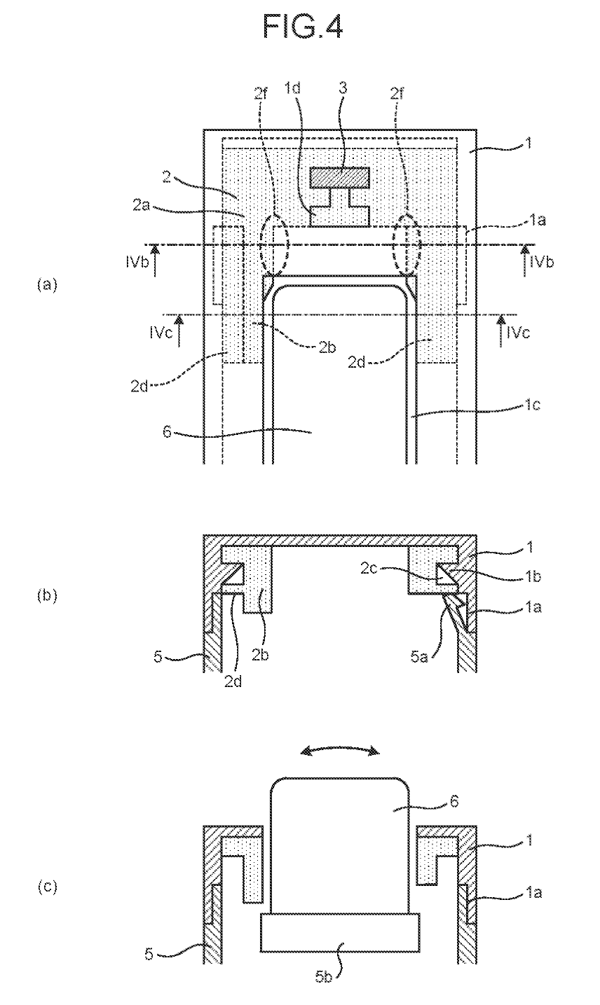

The locking and releasing of the holder 2 will be described. FIG. 3 is an upside view of the connector holding structure when the holder 2 is released (a holder released state). FIG. 4 is a schematic diagram of the connector holding structure in the holder released state; FIG. 4(a) is a perspective view as viewed upward; FIG. 4(b) is a cross-sectional view along line IVb-IVb in FIG. 4(a); and FIG. 4(c) is a cross-sectional view along line IVc-IVc in FIG. 4(a). The lever 3 is placed on the closer-to-the-end side along a longitudinal direction of the faceplate 1. As shown in FIG. 4(b), in the holder released state, the notched portion 2d is located in front of the recess 1a and the claw tab 5a, and a space for a bend margin exists in front of the claw tab 5a. Thus, it is possible to bend the claw tab 5a to fit into the recess 1a of the faceplate 1 and to detach the claw tab 5a from the recess 1a.

Further, as shown in FIG. 4(a), in the holder released state, the connector support portion 2f is almost not exposed through the connector opening 1c, and the arm 2b is a predetermined distance or greater away from the side surface of the cable-side connector 6. Therefore, the holder 2 does not hinder the cable-side connector 6 from being attached to and detached from the apparatus-side connector 5b on the apparatus side. As shown in FIG. 4(c), in this state, the inclination of the cable-side connector 6 is not restricted.

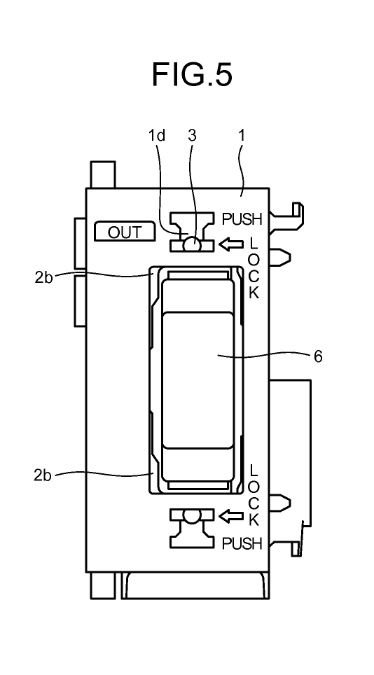

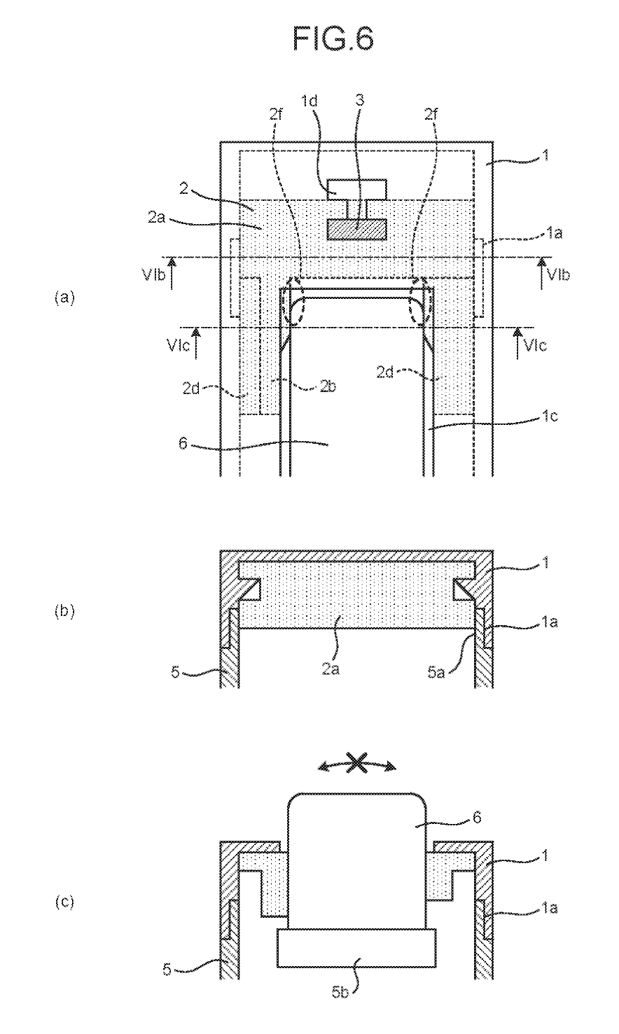

FIG. 5 is an upside view of the connector holding structure when the holder 2 is locked (a holder locked state). FIG. 6 is a schematic diagram of the connector holding structure in the holder locked state; FIG. 6(a) is a perspective view as viewed upward; FIG. 6(b) is a cross-sectional view along line VIb-VIb in FIG. 6(a); and FIG. 6(c) is a cross-sectional view along line VIc-VIc in FIG. 6(a). The lever 3 is placed on the center side along the longitudinal direction. As shown in FIG. 6(b), in the holder locked state, the base 2a is located in front of the recess 1a and the claw tab 5a, and a space for a bend margin does not exist in front of the claw tab 5a. Thus, the claw tab 5a cannot be bent, and hence the faceplate 1 and the case 5 do not separate in the holder locked state.

Further, as shown in FIG. 6(a), in the holder locked state, the connector support portion 2f is exposed through the connector opening 1c at positions adjacent to an end along a longitudinal direction thereof, and the arm 2b is at a shorter distance than the predetermined distance from the side surface of the cable-side connector 6. Thus, as shown in FIG. 6(c), the gap between the cable-side connector 6 and the housing becomes narrower, so that the inclination of the cable-side connector 6 can be suppressed. Therefore, the cable-side connector 6 of a single-sided spring structure can be reliably rendered conductive. The longer the area at which the arm 2b and the cable-side connector 6 are in contact, the greater the effect of suppressing the inclination of the cable-side connector 6, and the shorter the area, the smaller the effect of suppressing the inclination of the cable-side connector 6. Hence, it is desirable that the length is at least 1.5 mm, preferably about 4.5 mm. Because the holder 2 suppressing the inclination of the cable-side connector 6 is attached to the faceplate 1, the force for suppressing the inclination of the cable-side connector 6 is applied to the case 5, not to the substrate on which the apparatus-side connector 5b is mounted. Thus, the wiring pattern of the substrate on which the apparatus-side connector 5b is mounted is not damaged, and therefore the endurance of the programmable controller can be improved.

In the holder released state and the holder locked state, part of the lever 3, down to the root of the operation portion 3a, protrudes from the faceplate 1, and hence the lever 3 is bound by the constriction of the operation opening 1d. By pushing in the lever 3 toward the case 5 against the repulsive force of the spring 4, the end thinner in width of the operation portion 3a becomes located in the operation opening 1d, and hence the lever 3 can be moved past the constriction of the operation opening 1d. After the operation to switch the states is performed, when the force pushing in the lever 3 toward the case 5 is relieved, part of the lever 3, down to the root of the operation portion 3a, is stuck out from the faceplate 1 due to the repulsive force of the spring 4. Thus, the movement of the lever 3 is again restricted by the constriction of the operation opening 1d. As such, in the present embodiment, the lever 3 and the spring 4 form a switching unit that causes the faceplate 1 to support the holder 2 in one of the position for the holder locked state and the position for the holder released state.

Although description has been made taking as an example the configuration where the operation openings are provided on the end sides along a longitudinal direction of the faceplate, the operation openings may be provided on the end sides along a transverse direction of the faceplate. However, where a plurality of apparatuses are installed in an arrangement, if the operation openings are provided on the end sides along a transverse direction of the connector opening, the levers will be located between cable-side connectors, resulting in the operation being difficult. Hence, it is preferable that the operation openings are provided in the ends along a longitudinal direction of the faceplate.

As described above, according to the present embodiment, an external connection connector can be held conductive without putting a load on the substrate and by simple lever operation, without adopting other members for fixing by use of a tool such as a driver.

### REFERENCE SIGNS LIST

1 Faceplate

1a Recess

1b Protrusion

1c Connector opening

2 Holder

2a Base

2b Arm

2c Groove

2d Notched portion

2e Step

2f Connector support portion

3 Lever

3a Operation portion

3b Fixed portion

3c Hook

4 Spring

5 Case

5a Claw tab

5b Apparatus-side connector

6 Cable-side connector

1. A connector holding structure of a programmable controller which includes a lower case shaped like a box with one surface open that houses a substrate on which an apparatus-side connector is mounted and an upper case shaped like a box with one surface open in which a connector opening through which a cable-side connector penetrates to be connected to the apparatus-side connector is formed in the surface opposite to the open surface, and in which the lower case and the upper case are detachably coupled together with the open surfaces opposite each other by fitting four claw tabs provided protruding from the edges surrounding the open surface of the lower case into four recesses provided in side surfaces of the upper case and close to both ends of the connector opening, the connector holding structure comprising:
a pair of holders each shaped substantially like a U and including a base and a pair of arms extending from both ends of the base, wherein the pair of arms includes a connector support portion in which the distance between inner side surfaces thereof is narrower at positions adjacent to the base than a width of the connector opening and notched portions for getting rid of interference with the claw tabs, and the pair of holders is placed respectively at both ends along a longitudinal direction of the connector opening and housed in the upper case; and
a switching unit that causes the upper case to support the holder in one of
a position for a holder locked state where the connector support portion is partly exposed through the connector opening at outer edges thereof and where the base is located in front of the claw tabs and the recesses and
a position for a holder released state where the connector support portion is not exposed through the connector opening and where the notched portion is located in front of the claw tabs and the recesses.

2. The connector holding structure according to claim 1, wherein
the switching unit has a lever attached to the holder in a push-in-able manner to move slidably together with the holder and an elastic member that biases the lever in a direction that the lever is stuck out from the holder,
the upper case includes an operation opening for the lever to penetrate through that is narrower in width in a center along a longitudinal direction of the upper case,
in the holder released state, the lever is placed on an end side of the upper case in the operation opening, and in the holder locked state, the lever is placed on a center side of the upper case in the operation opening, and
by pushing the lever into the holder, the lever can be moved past the center of the operation opening to slide the holder so as to transition between the holder released state and the holder locked state.

3. The connector holding structure according to claim 2, wherein the operation opening is provided adjacent to each end of the upper case along a longitudinal direction of the upper case.
